(19) United States
(12) Patent Application Publication
(10) Pub. No.: US 2005/0082399 A1
(43) Pub. Date: Apr. 21, 2005

(54) Submerged nozzle for a metallurgic container placed upstream from a casting device

(76) Inventors: Ina Lemanowicz, Neukirchen-Vluyn (DE); Hans Streubel, Erkrath (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/501,248

(22) PCT Filed: Jan. 22, 2003
(86) PCT No.: PCT/DE03/00186

(30) Foreign Application Priority Data
Jan. 23, 2002 (DE) 102 03 594.6

(51) Int. Cl. B05B 1/00

(52) U.S. Cl. 239/601; 239/597

(57) ABSTRACT

The invention is directed to an immersion nozzle for a metallurgic vessel arranged upstream of a casting device, in particular a continuous casting mold or a twin roller, in which a slit-shaped pour-out opening (2) having a length that is several times greater than its width is provided in the base area. The cross section widens in the direction of its mouth from a round inlet cross section to a mouth cross section whose one semiaxis is smaller than, and whose other semiaxis extending perpendicular thereto is greater than, the semiaxis of the round inlet cross section and whose base shape corresponds to that of the body of revolution of an ellipse or of an oval mouth cross section around the greater semiaxis, and the slit-shaped outlet opening extends in direction of the greater semiaxis.

The invention is directed to an immersion nozzle for a metallurgic vessel arranged upstream of a casting device in which a slit-shaped pour-out opening having a length that is several times greater than its width is provided in the mouth area.

By casting device is meant, for example, a continuous casting mold or a strip casting installation such as a twin roller.

An immersion nozzle of the type mentioned above is known from WO 98/53938. This immersion nozzle has a cylindrical shape with a circular, oval or bone-shaped cross section. The outlet opening is slit-shaped and extends continuously at the base and into the side wall of the cylindrical part of the immersion nozzle. With this construction of the immersion nozzle, a long useful life is achieved, as is guidance of the molten metal with little turbulence and a small penetration depth into the slab mold.

It is disadvantageous that the flow back to the casting surface is small in an immersion nozzle of this kind with slab widths above 1200 mm. This negatively affects casting slag formation because there is too little heat entering the casting surface due to insufficient flow and, therefore, inadequate supply of new hot molten metal into this area.

Therefore, it is the object of the invention to improve the immersion nozzle of the type mentioned above in such a way that there is an improvement in the flow profile even with larger slab widths.

In an immersion nozzle for a metallurgic vessel arranged upstream of a casting device in which a slit-shaped pour-out opening having a length that is several times greater than its width is provided in the mouth area, the above-stated object is met, according to the invention, in that its cross section widens in the direction of its mouth from a round inlet cross section to a mouth cross section whose one semiaxis is smaller than, and whose other semiaxis extending perpendicular thereto is greater than, the semiaxis of the circular inlet cross section and whose bottom shape or base shape corresponds to that of the body of revolution of an ellipse or of an oval mouth cross section around the greater semiaxis, and in that the slit-shaped outlet opening extends in direction of the greater semiaxis.

The mouth cross section can have the shape of an ellipse or rhombus, for example; but it is also possible for the mouth cross section to have a shape combining a round cross section and an ellipse-like cross section. The base of the mouth cross section preferably extends in an arc-shaped manner direction of the smaller semiaxis or, alternatively, in direction of the greater semiaxis.

The transition from the circular cross section to the widened cross section of the immersion nozzle can be formed as a function of the first or nth degree.

The slit-shaped pour-out opening preferably extends over the length of the entire base area. It can also extend in the side wall.

The shape of the slit-shaped pour-out opening can correspond to that of a rectangle.

According to another development, the width of the pour-out opening can increase outward from the center.

The funnel-shaped widening of an immersion nozzle, as such, is known per se. However, in the prior art the round inlet cross section changes to a slit-shaped mouth cross section, i.e., to a cross section whose length is substantially greater than its width. The entire mouth cross section therefore resembles the rectangular shape of the slab mold (DE 41 42 447).

The inventive funnel-shaped widening of the immersion nozzle from a round cross-sectional shape to, e.g., an elliptic mouth cross section changes the flow conditions inside and outside the immersion nozzle so that there is a widening of the flow in the casting direction and a stronger back-flow outside the immersion nozzle which, as a result of a greater heat input, leads in turn to an improved melting of the casting powder located on the surface of the melt.

The flow conditions are also substantially influenced by the base shape, specifically the inner shape and the outer shape, assuming in the present description that the inner base shape and outer base shape are substantially identical.

An embodiment example of the immersion nozzle according to the invention is shown in the drawing, specifically, in longitudinal cross section and in a side view.

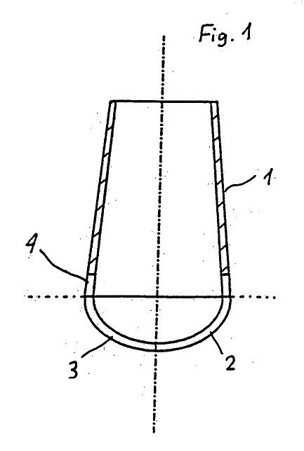

As can be seen from FIG. 1, which shows a longitudinal cross section, the cross section of the immersion nozzle 1 widens in the casting direction (arrow) from the round cross section to an elliptic cross section, wherein the funnel shape is formed in such a way that the extension of the smaller semiaxis of the ellipsoid is less than that of the one (corresponding) axis of the round upper inlet cross section.

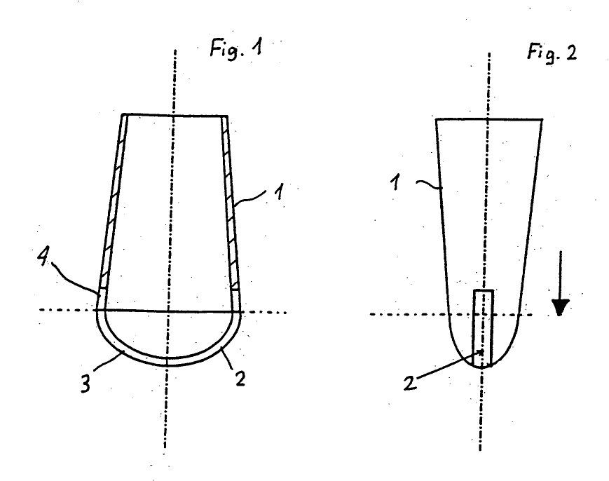

In the construction shown in FIG. 1 and FIG. 2, the slit-shaped pour-out opening 2 extends along the entire base area 3 into the side wall 4.

1. An immersion nozzle for a metallurgic vessel arranged upstream of a casting device, the immersion nozzle comprising:
a slit-shaped pour-out opening (2) having a length that is several times greater than its width provided in a base area of the immersion nozzle;
wherein the immersion nozzle has a cross section that widens in the direction of a mouth area from a round inlet cross section to a mouth cross section;
the mouth cross section having one semiaxis that is smaller than a semiaxis of the round inlet cross section, and another greater semiaxis extending perpendicular thereto that is greater than the semiaxis of the round inlet cross section; and
wherein the base area has a shape corresponding to that of a body of revolution of an ellipse or of an oval mouth cross section around the greater semiaxis, and the slit-shaped outlet opening extends in a direction of the greater semiaxis.

2. An immersion nozzle according to claim 1, wherein the mouth cross section has the shape of an ellipse.

3. An immersion nozzle according to claim 1, wherein the mouth cross section has the shape of a rhombus.

4. An immersion nozzle according to claim 1, wherein the mouth cross section has a shape combining a round cross section and ellipse-like cross section.

5. An immersion nozzle according to claim 1 wherein the base area of the mouth cross section extends in an arc-shaped manner in direction of the smaller semiaxis.

6. An immersion nozzle according to claim 1 wherein the base area of the mouth cross section extends in an arc-shaped manner in direction of the greater semiaxis.

7. An immersion nozzle according to claim 1 wherein the transition from the circular cross section to the widened cross section is formed as a function of a first degree.

8. An immersion nozzle according to claim 1 wherein the transition from the circular cross section to the widened cross section is formed as a function of an nth degree.

9. An immersion nozzle according to claim 1 wherein the slit-shaped pour-out opening (2) extends over the length of the entire base area.

10. An immersion nozzle according to claim 9, wherein the slit-shaped pour-out opening (2) extends in the side wall.

11. An immersion nozzle according to claim 1 wherein the shape of the slit-shaped pour-out opening (2) corresponds to a rectangle.

12. An immersion nozzle according claim 1 wherein the width of the pour-out opening increases outward from the center.

13. An immersion nozzle for a metallurigical casting device which acts as a guide for molten metal comprising:
a round inlet section located at a top end of the immersion nozzle and having a diameter oriented along a first axis;
a base area with a exit slot forming an elliptical mouth opening located at the other end of the immersion nozzle;
a top section with an increasing width towards the base area;
a bottom section with an increasing width towards the base area;
side wall sections connecting the top section to the bottom section and having a decreasing height towards the base area; and
wherein the elliptical mouth opening spans the width of the top section at the base area and further extends into the side wall sections.

14. The immersion nozzle of claim 13 wherein the wherein the elliptical mouth opening shape widens a flow of the molten metal and creates a backflow outside the immersion nozzle which provides improved melting of casting powder located on the surface of a melt.
